(19) United States
(12) Patent Application Publication
(10) Pub. No.: US 2008/0168646 A1
(43) Pub. Date: Jul. 17, 2008

(54) COMPUTER CASE INCLUDING CARBON FIBER AND METHOD OF MANUFACTURING COMPUTER CASE

(76) Inventor: Carl Fiorentino, Fletcher, OH (US)

Correspondence Address: GREENBERG TRAURIG, LLP, MET LIFE BUILDING, 200 PARK AVENUE, NEW YORK, NY, 10166, US

(21) Appl. No.: 11/684,361

(22) Filed: Mar. 9, 2007

Related U.S. Application Data
(60) Provisional application No. 60/886,127, filed on Jan. 23, 2007.
(60) Provisional application No. 60/885,253, filed on Jan. 17, 2007.

(51) Int. Cl. B23P 11/00

(52) U.S. Cl. 29/428

(57) ABSTRACT

One embodiment of the present invention relates to a computer case including carbon fiber. Another embodiment of the present invention relates to a method of manufacturing a computer case. In one example, the computer case may be for a desktop computer (e.g., a personal computer or “PC”). In another example, the carbon fiber may be integrated into the computer case in the form of one or more panels.

### RELATED APPLICATIONS

This application claims the benefit of U.S. Provisional Application Ser. No. 60/886,127, filed Jan. 23, 2007 and U.S. Provisional Application Ser. No. 60/885,253, filed Jan. 17, 2007. Each of the aforementioned applications is incorporated herein by reference in its entirety.

### FIELD OF THE INVENTION

One embodiment of the present invention relates to a computer case including carbon fiber.

Another embodiment of the present invention relates to a method of manufacturing a computer case.

In one example, the computer case may be for a desktop computer (e.g., a personal computer or “PC”).

In another example, the carbon fiber may be integrated into the computer case in the form of one or more panels.

For the purposes of describing and claiming the present invention, the term “carbon fiber” is intended to refer to carbon filament thread or to felt or woven cloth made from such carbon filament thread.

Further, for the purposes of describing and claiming the present invention, the term “assembly line” is intended to refer to an assembly method utilized by a manufacturer for producing a relatively high number of identical or related products.

Further still, for the purposes of describing and claiming the present invention, the term “manufacturer” is intended to refer to the producer of a relatively high number of identical or related products ultimately bound for retail sale.

Further still, for the purposes of describing and claiming the present invention, the term “end user” is intended to refer to the ultimate user (e.g., retail purchaser) of a product manufactured by a manufacturer.

### BACKGROUND OF THE INVENTION

Examples of utilization of carbon fiber in connection with computer cases include the following: the Sony VAIO TX series (see Mobile Magazine article entitled “Sony VAIO TX Series made of Carbon Fiber); and case modding (see, Mashie Design article entitled “Carbon Fiber—a different case mod material” and Moddin.net article discussing a case project by Jordanis3r).

### BRIEF DESCRIPTION OF THE DRAWINGS

FIG. 1 shows a first perspective view of a computer case according to one embodiment of the present invention;

FIG. 2 shows another perspective view of the computer case of FIG. 1;

FIG. 3 shows another perspective view of the computer case of FIG. 1;

FIG. 4 shows a detail view of a carbon fiber panel of the computer case of FIG. 1; and

FIG. 5 shows a detail view of a carbon fiber panel of the computer case of FIG. 1.

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

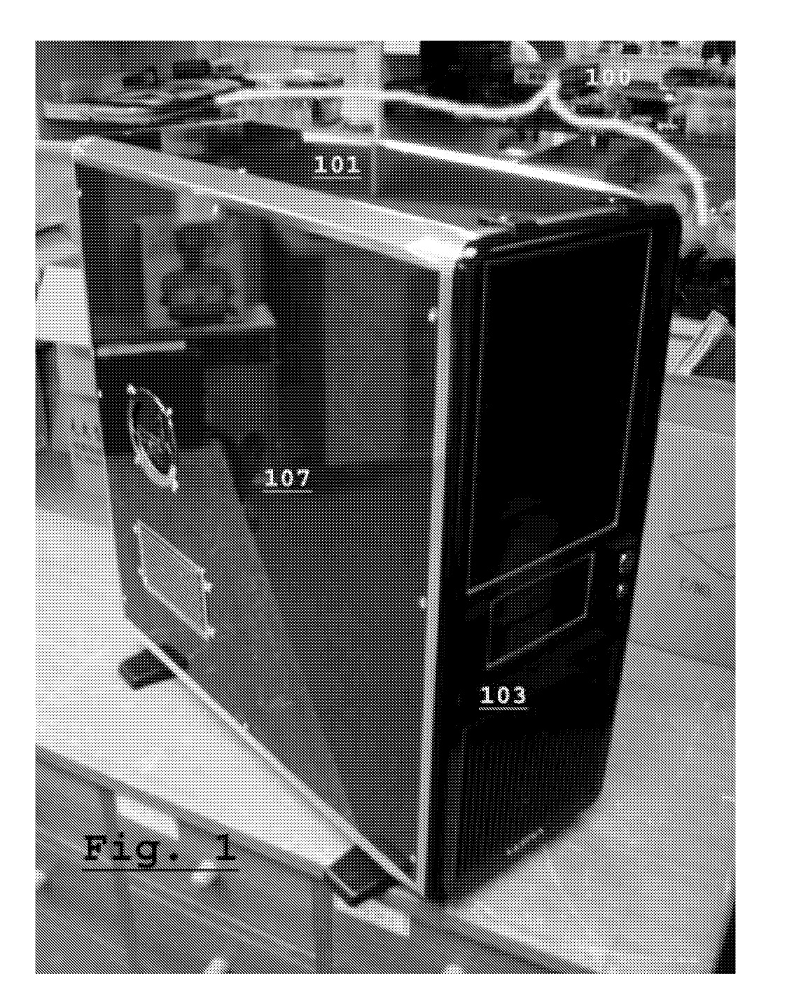

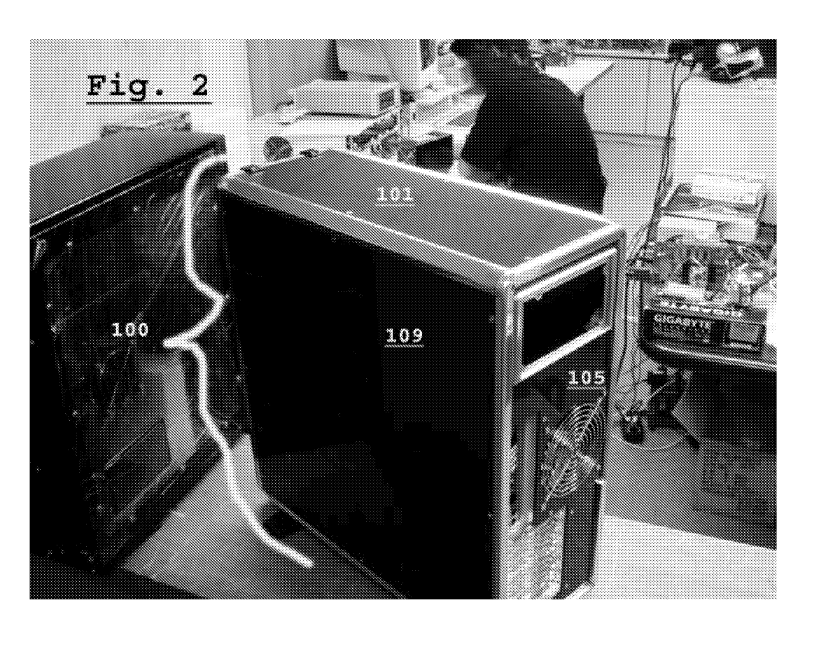

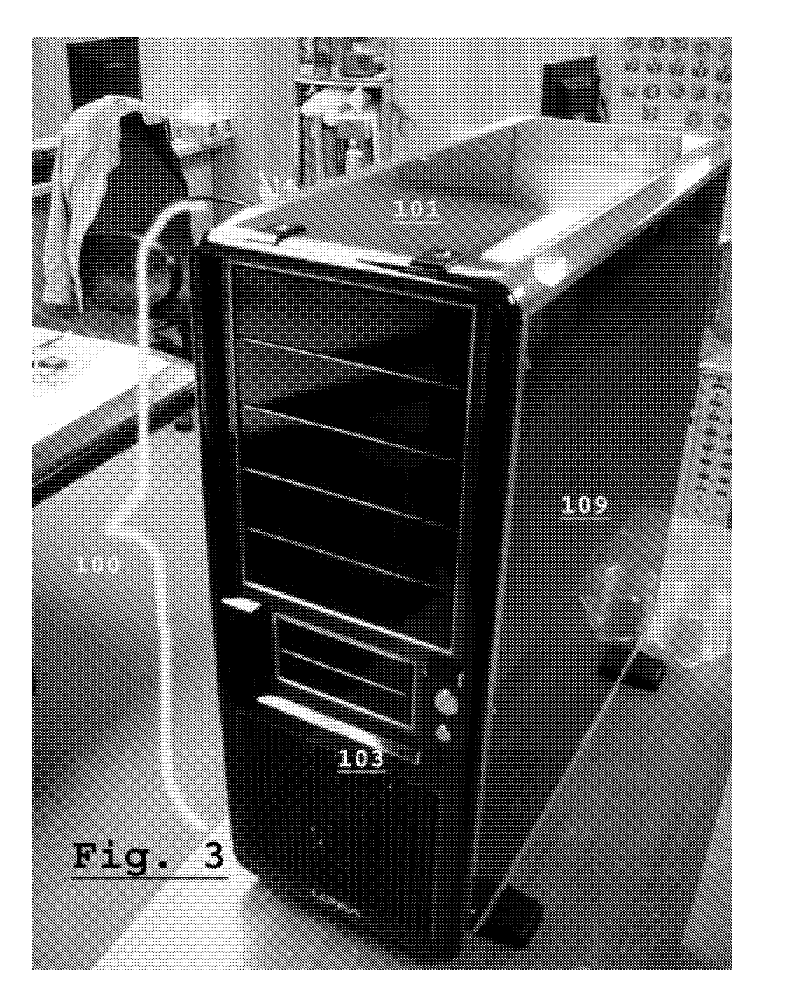

Referring now to FIGS. 1-5, it is seen that one embodiment of the present invention may relate to a computer case including carbon fiber (the computer case may include therein various computer components such as, for example, a motherboard, a video display card and a hard drive). In the example of these FIGS. 1-5, the computer case is for a desktop computer (e.g., a personal computer or “PC”). In one specific example, the carbon fiber may be integrated into the computer case in the form of one or more panels.

Still referring to FIGS. 1-5, it is seen that computer case 100 may include (attached to a computer frame) top carbon fiber panel 101, front carbon fiber panel 103, rear carbon fiber panel 105, first side carbon fiber panel 107, and second side carbon fiber panel 109 (although not shown in the Figs., a bottom carbon fiber panel may be utilized).

Of note, the carbon fiber panels may be made, for example, via a “wet” layup process (in which dry carbon fiber is laid in a mold and resin is poured or bushed over the carbon fiber) and/or, for example, via a “pre-impregnated” process.

In another example, carbon fiber may be utilized as a front panel for a computer case, a rear panel for a computer case, one or more side panels for a computer case, a top panel for a computer case and/or a bottom panel for a computer case.

In another example, one or more conventional metal panels for a computer case may be replaced by one or more carbon fiber panels (e.g. all conventional metal panels may be easily replaced by corresponding carbon fiber panels or less than all conventional metal panels may be easily replaced by corresponding carbon fiber panels).

In another example, one or more installed carbon fiber panels for a computer case may be replaced by one or more other carbon fiber panels (e.g. all installed carbon fiber panels panels may be easily replaced by corresponding other carbon fiber panels or less than all installed carbon fiber panels may be easily replaced by corresponding other carbon fiber panels).

In another example, the carbon fiber panels may be finished, but unpainted.

In another example, the carbon fiber panel(s) may be attached to a semi-exposed frame, such as shown in FIGS. 1-5 (e.g., a semi-exposed metal frame).

In another example, the carbon fiber panel(s) may be attached to a frame that is not exposed, that is, a frame that is essentially entirely covered by the carbon fiber panel(s) (e.g., a non-exposed metal frame).

In another example, each carbon fiber panel may essentially entirely cover a top, bottom, front, rear and/or side of the computer case.

In another example, each carbon fiber panel may cover less than the entire area of a top, bottom, front, rear and/or side of the computer case.

In another example, each carbon fiber panel may be integrated with another material (e.g., metal or plastic).

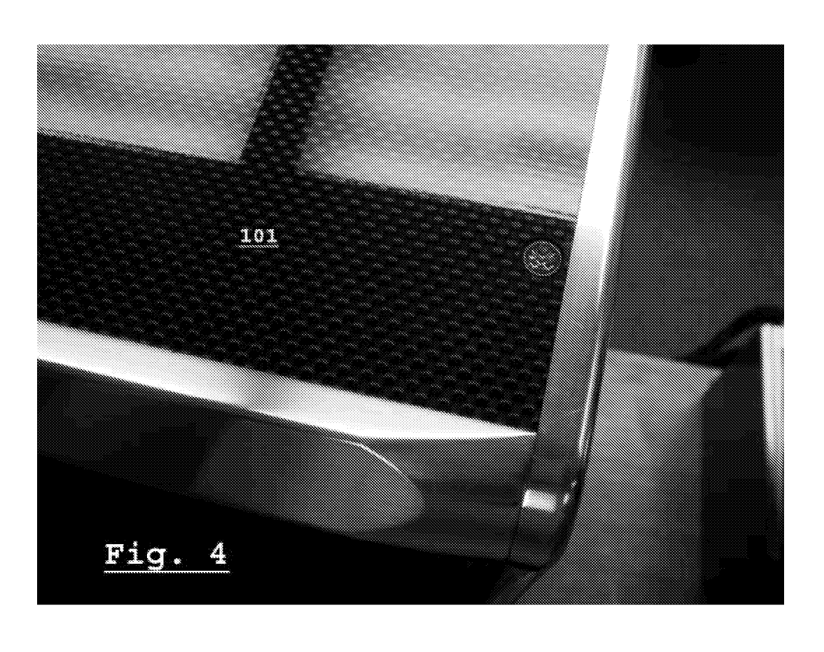

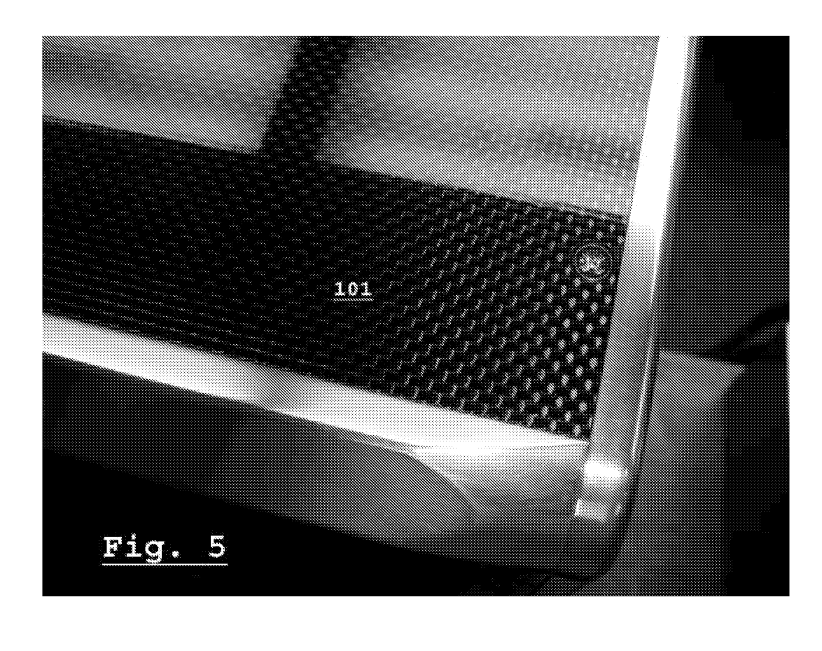

While a number of embodiments of the present invention have been described, it is understood that these embodiments are illustrative only, and not restrictive, and that many modifications may become apparent to those of ordinary skill in the art. For example, the present invention is intended to include one or more methods for constructing the type of computer case described herein. Further, the carbon fiber panel(s) may include one or more holes, slots and/or other openings (e.g., to aid in cooling, to permit attachment of peripheral devices, to permit operation of switches, etc.). Further still, the carbon fiber panel(s) may be attached with one or more screws (see, e.g., the flush mount screw configuration shown in FIGS. 4 and 5) and/or one or more other attachment mechanisms (e.g., adhesive, double-sided tape, nut-and-bolt, etc.). Further still, any steps described herein may be carried out in any desired order (and any steps may be added and/or deleted).

What is claimed is:

1. A computer manufacturing method, comprising:
assembling, on an assembly line, a computer frame for a desktop computer;
installing within the computer frame, on an assembly line, a plurality of components; and
attaching to the computer frame, on an assembly line, at least one carbon fiber panel.

2. The method of claim 1, wherein the same assembly line is used for each step.

3. The method of claim 1, wherein the desktop computer is a PC.

4. The method of claim 1, wherein the components comprise a motherboard, a video display card and a hard drive.

5. The method of claim 2, wherein the assembly line is an automated assembly line.

6. The method of claim 1, wherein the attaching to the computer frame, on an assembly line, at least one carbon fiber panel farther comprises attaching to the computer frame, on an assembly line, at least one carbon fiber panel selected from the group consisting of: (a) a top panel; (b) a bottom panel; (c) a side panel; (d) a front panel; and (e) a rear panel.

7. The method of claim 1, wherein the carbon fiber panel is removably attached to the computer frame.

8. The method of claim 7, wherein the carbon fiber panel is removably attached to the computer frame using at least one screw.

9. The method of claim 1, further comprising forming the parts of the computer frame.

10. The method of claim 9, wherein the parts of the computer frame are formed of metal.

11. The method of claim 1, wherein the steps are carried out in the order recited.

12. A computer assembly method, comprising:
assembling a computer frame for a desktop computer;
installing within the computer frame a plurality of components;
attaching to the computer frame a plurality of cover panels;
providing at least one carbon fiber panel;
removing at least one of the plurality of cover panels that had been attached to the computer frame; and
attaching to the computer frame at least one carbon fiber panel in place of the removed cover panel.

13. The method of claim 12, wherein the desktop computer is a PC.

14. The method of claim 12, wherein the components comprise a motherboard, a video display card and a hard drive.

15. The method of claim 12, wherein each of the steps of assembling a computer frame, installing within the computer frame a plurality of components, and attaching to the computer frame a plurality of cover panels is carried out on an assembly line.

16. The method of claim 15, wherein the same assembly line is used for each step.

17. The method of claim 16, wherein the assembly line is an automated assembly line.

18. The method of claim 12, wherein the attaching to the computer frame at least one carbon fiber panel further comprises attaching to the computer frame at least one carbon fiber panel selected from the group consisting of: (a) a top panel; (b) a bottom panel; (c) a side panel; (d) a front panel; and (e) a rear panel.

19. The method of claim 12, wherein the carbon fiber panel is removably attached to the computer frame.

20. The method of claim 19, wherein the carbon fiber panel is removably attached to the computer frame using at least one screw.

21. The method of claim 12, further comprising forming the parts of the computer frame.

22. The method of claim 2 1, wherein the parts of the computer frame are formed of metal.

23. The method of claim 12, wherein:
the steps of assembling a computer frame for a desktop computer; installing within the computer frame a plurality of components; attaching to the computer frame a plurality of cover panels; and providing at least one carbon fiber panel are carried out by a manufacturer; and
the steps of removing at least one of the plurality of cover panels that had been attached to the computer frame; and attaching to the computer frame at least one carbon fiber panel in place of the removed cover panel are carried out by an end user.

24. The method of claim 12, wherein the steps are carried out in the order recited.
